(19) United States
(12) Patent Application Publication
(10) Pub. No.: US 2025/0232599 A1
(43) Pub. Date: Jul. 17, 2025

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventors: Makoto TOMIOKA, Kanagawa (JP); Kazuhiko KOBAYASHI, Kanagawa (JP)

(21) Appl. No.: 19/098,500

(22) Filed: Apr. 2, 2025

Related U.S. Application Data
(63) Continuation of application No. PCT/JP2023/031857, filed on Aug. 31, 2023.

(30) Foreign Application Priority Data
Oct. 5, 2022 (JP) 2022-161081

(51) Int. Cl. G06V 20/64; G06F 16/51; G06T 7/70; G06T 17/00; G06V 20/70

(52) U.S. Cl. CPC G06V 20/653; G06F 16/51; G06T 7/70; G06T 17/00; G06V 20/70; G06T 2207/20081; G06T 2207/20084

(57) ABSTRACT

An information processing apparatus includes an object property group information input unit configured to input object property group information that includes at least two or more pieces of object property information, the object property information including type information that represents names of types of objects and information regarding three-dimensional positions of the objects in a space; an object disposition property database that holds the type information that represents the names of the types of the objects and the information regarding the three-dimensional positions of the objects in the space in an associated manner; a prediction unit configured to predict information related to the information included in the object property group information on the basis of the object property group information input by the object property group information input unit and the object disposition property database; and an object disposition property database updating unit configured to update the object disposition property database on the basis of the object property group information input by the object property group information input unit and a result of the prediction of the prediction unit.

### CROSS-REFERENCE TO RELATED APPLICATIONS

This application is a Continuation of International Patent Application No. PCT/JP2023/031857, filed Aug. 31, 2023, which claims the benefit of priority from Japanese Patent Application No. Japanese Patent Application No. 2022-161081, filed on Oct. 5, 2022, both of which are hereby incorporated by reference herein in their entirety.

### BACKGROUND OF THE INVENTION

### Field of the Invention

The present invention relates to an information processing apparatus, a method of controlling an information processing apparatus, and a storage medium.

### Description of the Related Art

In recent years, image recognition has enabled machines to recognize object properties such as types and positions of objects appearing in images. According to WO2018/021576, a database is updated to output a bounding box surrounding an object and an object type from an image.

However, objects are not recognized in some cases in image recognition regardless of the objects appearing in images. Also, it is necessary to construct a database from the beginning for each of such recognition tasks, and this takes time and effort. Therefore, there is room for improvement in processing related to image recognition in the related art.

### SUMMARY OF THE INVENTION

An information processing apparatus according to an aspect of the present invention includes:
an object property group information input unit configured to input object property group information that includes at least two or more pieces of object property information, the object property information including type information that represents names of types of objects and information regarding three-dimensional positions of the objects in a space;
an object disposition property database that holds the type information that represents the names of the types of the objects and the information regarding the three-dimensional positions of the objects in the space in an associated manner;
a prediction unit configured to predict information related to the information included in the object property group information on the basis of the object property group information input by the object property group information input unit and the object disposition property database; and
an object disposition property database updating unit configured to update the object disposition property database on the basis of the object property group information input by the object property group information input unit and a result of the prediction of the prediction unit.

Further features of the present invention will become apparent from the following description of embodiments with reference to the attached drawings.

### BRIEF DESCRIPTION OF THE DRAWINGS

FIG. 1 is a diagram for explaining a situation in which an information processing apparatus according to the present invention is used.

FIG. 2 is a block diagram illustrating a functional configuration of an information processing apparatus according to a first embodiment.

FIG. 3 is a diagram illustrating a hardware configuration of the information processing apparatus according to the first embodiment.

FIG. 4 is a diagram illustrating a concept of the first embodiment.

FIG. 5 is a flowchart illustrating a flow of processing of the information processing apparatus according to the first embodiment.

FIG. 6 is a flowchart illustrating a detailed flow of prediction processing of the information processing apparatus according to the first embodiment.

FIG. 7 is a block diagram illustrating a functional configuration of an information processing apparatus according to a second modification example.

FIG. 8 is a diagram illustrating a concept of a third modification example.

FIG. 9 is a diagram illustrating variations of a task database illustrated in FIG. 8.

FIG. 10 is a block diagram illustrating a functional configuration of an information processing apparatus according to a second embodiment.

FIG. 11 is a flowchart illustrating a flow of processing of the information processing apparatus according to the second embodiment.

### DESCRIPTION OF THE EMBODIMENTS

Hereinafter, embodiments will be described in detail with reference to the accompanying drawings. Note that the following embodiments are not intended to limit the invention described in the claims. Although a plurality of features are described in the embodiments, all of the plurality of features are not necessarily essential for the invention, and the plurality of features may be arbitrarily combined. Furthermore, the same or similar configurations are denoted by the same reference signs in the accompanying drawings, and repeated description will be omitted.

Image recognition and three-dimensional space recognition are one of the most basic problems in computer vision. The image recognition and the three-dimensional space recognition are used not only for the purpose of recognizing types of articles, grasping the positions, and counting the number of articles, and they are also applied to a variety of tasks such as location recognition, obstacle avoidance for automatic driving, risk prediction, and the like.

Object detection from images or three-dimensional shape models is realized by, for example, neural networks that select focused regions (rectangles) and determine types of objects included therein.

On the other hand, the object detection performed until now has been specialized for detection of individual objects. In other words, it has not been possible to use relationships (particularly, positional relationships) among the objects. In particular, “article disposition properties” that are common knowledge for persons, such as a property that chairs are likely to be located beside tables while chairs are unlikely to be located on tables, and a property that tables and chairs are typically located indoors rather than outdoors, have been ignored in many cases in recognition using calculators.

Disposition properties in the embodiments of the present invention mean properties of relationships among articles such as combination patterns and appearance frequencies of positional relationships and contact relationships among articles in such a real space, temporal changes thereof, and occurrence probabilities thereof.

In the embodiments of the present invention, information related to articles in a real space and relationships among the articles is predicted on the basis of an object disposition property database aggregating “disposition relationships of articles” in the real space. In particular, a configuration of predicting types of undetected object (unknown object) that has not yet been able to be recognized or an object that has been failed to be recognized from a disposition relationship of objects in the surroundings will be described in the present embodiments.

### Overview of Operations

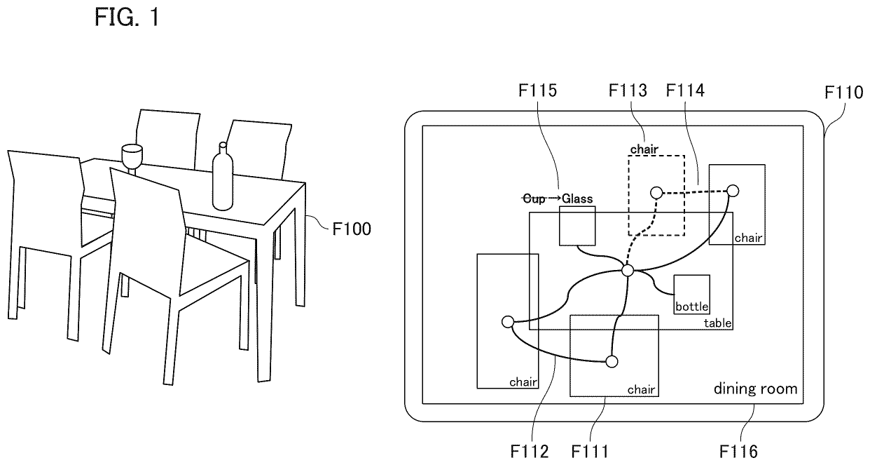

FIG. 1 is a diagram for explaining a situation in which an information processing apparatus according to the embodiments of the present invention is used. An environment F100 denotes how a table and chairs are installed in a dining room as an example of an actual environment. A tablet F110 is a tablet as an example of the information processing apparatus to which the embodiments of the present invention are applied, and presents a three-dimensional shape model of the environment F100 three-dimensionally restored by a camera which is mounted on a rear surface and is not illustrated in the drawing.

A result of recognizing the three-dimensional shape model, objects included therein, and relationships of the positions is presented on a display of the tablet F110. The display presents a plurality of rectangles F111 indicated by solid lines.

The plurality of rectangles F111 are the objects (the chairs and the table) detected from the three-dimensional shape model. The plurality of rectangles F111 is connected by line segments F112 in accordance with disposition properties. The display presents an object that has not been able to be detected directly from the three-dimensional shape model, such as a chair with a large part hidden by the table, by a rectangle F113 indicated by the dashed line.

The rectangle F113 is presented by a result of analogy based on an object disposition property database according to the embodiments of the present invention, which will be described later. The object disposition property database according to the embodiments of the present invention analogizes that there seems to be a hidden chair from the aligned chairs and table and analogizes the rectangle F113 connected to the rectangle F111 by a line segment F114 indicated by the dashed line.

Also, a rectangle F115 indicates a result of analogy as a glass on the basis of the object disposition property database according to the embodiments of the present invention although it had been estimated as a cup from the three-dimensional shape model. The object disposition property database according to the embodiments of the present invention analogizes that the article is a glass instead of a cup because a bottle is placed on the same table.

Furthermore, the display of the tablet F110 presents, in the environment presenting area F116, a result of estimation that the environment is a dining room on the basis of the disposition property of the environment where the table and the chairs are aligned.

### First Embodiment

Hereinafter, a first embodiment of the present invention will be described. In the first embodiment, a method of using the object disposition property database for prediction of labeling of a three-dimensional shape model in which labels of types of objects that are present in an environment have been applied will be described.

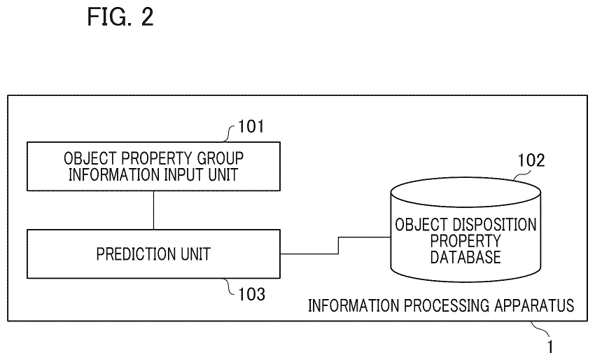

In other words, labels for objects with unknown labels in the three-dimensional model and objects with incorrect labels applied thereto are predicted. FIG. 2 is a block diagram illustrating a functional configuration of an information processing apparatus according to the first embodiment. An information processing apparatus 1 includes an object property group information input unit 101, an object disposition property database 102, and a prediction unit 103.

The object property group information input unit 101 receives an input of object property group information from a holding unit (not illustrated) that holds the object property group information, for example, and outputs the input object property group information to the prediction unit 103. The holding unit is provided outside the information processing apparatus 1, for example.

The object property information includes position information including object type information in which a number label is allocated to each type (for example, a table, a chair, a wall, or a floor) of object that is present in an environment and three-dimensional coordinates (X, Y, Z) of the object.

These are assumed to be generated from a three-dimensional shape model that has been three-dimensionally restored by structure from motion (SfM) or simultaneous localization and mapping (SLAM).

The object property group information includes a plurality of pieces of object property information included in a certain environment (that is, a certain three-dimensional shape model). The object property group information includes at least two or more pieces of object property information including type information representing names of types of objects and three-dimensional position information of the objects in the space.

The three-dimensional shape model is a data structure in which article instance IDs (which of objects that are present in the environment) and types of the objects are applied to three-dimensional point cloud in the present embodiment. In other words, an ID indicating which object each point cloud corresponds to and what kind of object the point cloud corresponds to is applied to each point cloud.

Such a three-dimensional shape model can be generated by a known method, for example. The known method is, for example, a method described in “CNN-SLAM: Real-time dense monocular SLAM with learned depth prediction”, Tateno et. al, CVPR2019.

Hereinafter, “CNN-SLAM: Real-time dense monocular SLAM with learned depth prediction”, Tateno et. al, CVPR2019 will be referred to as Reference Document 1.

Details of generation of the three-dimensional shape model will be described later. The position information of the objects is created by extracting positions of gravity centers of sets of point cloud with the same instance IDs from among the three-dimensional point cloud, and the types of the objects are created by extracting object IDs of the instances as type information of the objects.

The object disposition property database 102 is a database that holds disposition properties that represent positional relationships of the plurality of objects. The disposition properties are knowledge data obtained by generalizing three-dimensional positional relationships of articles in the actual world.

Specifically, properties such as a property that “chairs are likely to be located besides tables while chairs are not located on the tables” and a property that “chairs and tables are typically located indoors rather than outdoors” as described above are held in the object disposition property database 102.

It is also possible to state that the properties held by the object disposition property database 102 are a property of what kinds of article disposition are typically chosen and a property of what kinds of disposition are not typically chosen in reality, for example.

The object disposition property database 102 in the present embodiment is a previously trained neural network that has been trained to infer unknown or incorrect object property information from object property information in the surroundings.

Specifically, the object disposition property database 102 is a trained neural network obtained by stacking twenty four layers of Transformer of Ashish et. al., (“Attention is All You Need”, Ashish. et. al, NeuralIPS2017).

In the present embodiment, the number of input dimensions and the number of output dimensions of the transformer are 512, that is, 512 pieces of object property information at maximum are input, and the same number of, that is, 512 dimensions of outputs are obtained in this configuration. Specifically, an encoder network used in the method of Jacob et. al. (the method described in Non-Patent Document 1: Jacob. et. al, BERT: Pre-training of Deep Bidirectional Transformers for Language Understanding, arXiv 2018) is adopted. Note that a method in which the neural network learns the object disposition properties in the present embodiment will be described in a second embodiment.

The prediction unit 103 predicts unknown or incorrect object property information in the object property information included in the object property group information from the object property information in the surroundings, using the object property group information input by the object property group information input unit 101 and the object disposition property database 102. The prediction unit 103 outputs a result of the prediction. The result of the prediction performed by the prediction unit 103 is held by the holding unit, which is not illustrated. The holding unit is provided outside the information processing apparatus 1, for example.

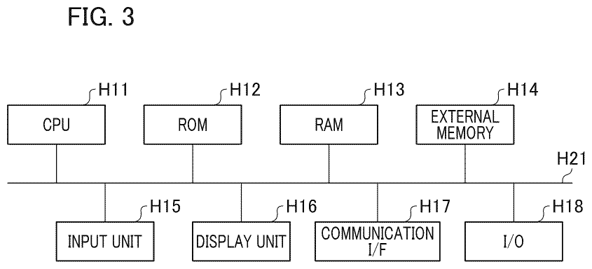

FIG. 3 is a diagram illustrating a hardware configuration of the information processing apparatus according to the first embodiment. In FIG. 3, H11 denotes a CPU, H12 denotes a ROM, and H133 denotes a RAM. The information processing apparatus 1 includes the CPU H11, the ROM H12, and the RAM H13.

CPU is an abbreviation of a central processing unit. ROM is an abbreviation of a read only memory. RAM is an abbreviation of a random access memory.

In FIG. 3, H17 denotes a communication I/F, and H18 denotes an I/O. The information processing apparatus 1 includes an external memory H14, an input unit H15, a display unit H16, a communication I/F H17, and an I/O H18. I/F is an abbreviation of an interface. I/O is an abbreviation of input/output. The information processing apparatus 1 further includes a system bus H21 that connects the above devices to each other.

The processing in the present embodiment is executed by the CPU H11 executing a software program according to the present embodiment. Also, the CPU H11 controls each device connected to the system bus H21. The ROM H12 stores a program of a BIOS and a boot program.

BIOS is an abbreviation of a basic input output system. The RAM H13 is used as a main storage device of the CPU H11. The external memory H14 stores the program that is to be executed by the CPU H11.

The input unit H15 performs processing regarding inputs of information and the like from a keyboard, a mouse, and the like. The keyboard, the mouse, and the like may be included in the information processing apparatus 1 or may be provided outside the information processing apparatus 1. The display unit H16 outputs a computation result and the like of the information processing apparatus 1 to a display device in response to an instruction from the CPU H11.

Note that the display device may be any display device such as a liquid crystal display device, a projector, or an LED indicator. The display device may be included in the information processing apparatus 1 or may be provided outside the information processing apparatus 1.

The communication I/F H17 performs communication between the information processing apparatus 1 and the outside. An object property information input unit 101 and the prediction unit 103 receive inputs of object property group information and output the result of prediction via the communication I/F H17.

The communication I/F H17 is adapted to perform information communication via a network, and the communication interface may be an Ethernet or may be any type of communication interface such as a USB, serial communication, wireless communication, or the like. USB is an abbreviation of a universal serial bus. The I/O H18 performs inputs and outputs of each device connected to the system bus H21.

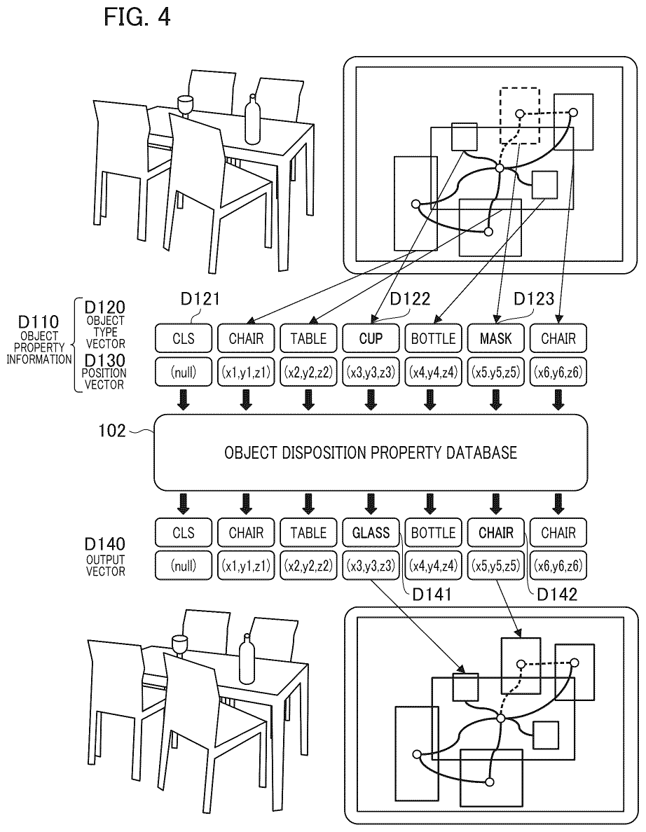

FIG. 4 is a diagram illustrating a concept of the first embodiment. FIG. 4 illustrates an overview of processing of predicting labels of objects with unknown labels applied thereto or of objects with incorrect labels applied thereto in a three-dimensional model using the object disposition property database 102.

D110 denotes object property information generated from the three-dimensional shape model. An object type vector D120 and a position vector D130 included in the object property information D110 are input data of the object disposition property database 102. The object type vector D120 is an example of object type information. The position vector D130 is an example of position information. The object type vector D120 is constituted by an object type information group including a plurality of pieces of object type information.

The object type vector D120 is a one-dimensional column vector. The first element of the object type vector D120 is a CLS token (a special label representing a start of the data) as indicated by D121. The object type vector D120 includes, following the CLS token D121, an object label corresponding to each piece of object type information included in the object type information group.

In the example in FIG. 4, the object type vector D120 includes, following the CLS token D121, an object label “chair” corresponding to the first object type information included in the object type information group. The object type vector D120 includes, following the object label corresponding to the first object type information, an object label “table” corresponding to the second object type information included in the object type information group.

The object type vector D120 includes the following object labels up to an object label corresponding to the last object type information included in the object type information group in order. In this manner, the object type vector D120 is a vector in which the object type labels of all the objects that are present in the environment are aligned in order.

Note that a mask token of D123 (a special label that indicates the object type is not known) is arranged as a label corresponding to an unknown object that has not yet been determined in the object type vector D120. Also, D122 is an incorrect label that has been recognized as a cup in the three-dimensional shape model although D122 is actually a glass.

The position vector D130 is a vector in which three elements, namely three-dimensional positions X, Y, and Z of each object aligned as column vectors are aligned as a one-dimensional column vector. In other words, each column of the position vector D130 stores X, Y, and Z value that are position coordinates of the object of the corresponding column included in the object type vector D120.

The object disposition property database 102 receives inputs of the object type vector D120 and the position vector D130 and obtains an output vector denoted by D140. In the present embodiment, the output vector D140 is a vector with the same size as that of the inputs to the object disposition property database 102.

In the output vector D140, the incorrect label D122 is replaced with a label D141 predicted using the object disposition property database 102 on the basis of a weight of the neural network held by the object disposition property database 102.

Also, in the output vector D140, the unknown label D123 is replaced with a label D142 predicted using the object disposition property database 102 on the basis of a weight of the neural network held by the object disposition property database 102. The information processing apparatus 1 changes the type of object of the three-dimensional model on the basis of such a label of the output vector D140.

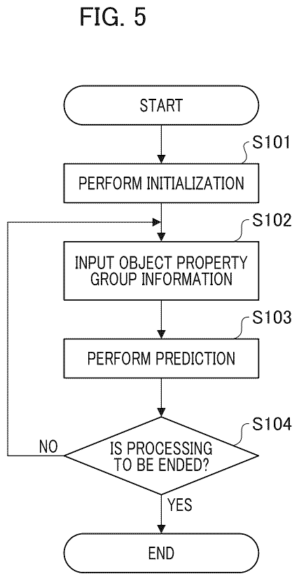

FIG. 5 is a flowchart illustrating a flow of processing of the information processing apparatus according to the first embodiment. The processing in FIG. 5 is automatically started by the information processing apparatus 1 being turned on and the information processing apparatus 1 being activated, for example.

In Step S101, the information processing apparatus 1 initializes the system. In other words, the CPU H11 reads and executes a program from the external memory H14 and brings the information processing apparatus 1 into an operatable state.

Also, the CPU H11 reads a weight parameter of the neural network which is the object disposition property database 102 from the external memory H14 as needed and develops the weight parameter in the RAM H13. Once the series of initialization processing in Step S101 ends, the information processing apparatus 1 executes processing in Step S102.

In Step S102, the object property group information input unit 101 receives an input of the object property group information from the holding unit. Also, in Step S102, the object property group information input unit 101 converts the input object property group information into information with a data structure that can be recognized by the object disposition property database 102 and outputs the information with the data structure to the prediction unit 103.

The data structure that can be recognized by the object disposition property database 102 is a feature vector (object type vector) in which object type labels are aligned and a position vector that represents the positions of the objects.

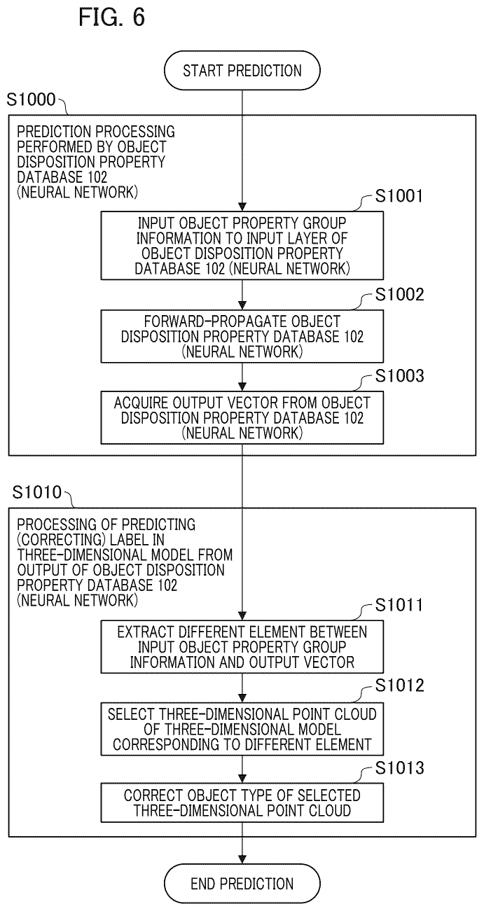

In Step S103, the prediction unit 103 inputs the object type vector and the position vector to the object disposition property database 102 and executes prediction processing. FIG. 6 is a flowchart illustrating a detailed flow of the prediction processing of the information processing apparatus 1 and is a diagram illustrating details of the processing in Step S103 in FIG. 5.

Processing in Step S1000 in FIG. 6 is processing in which the prediction unit 103 predicts a mask token and an incorrect object type label on the basis of the object disposition property database 102. Processing in Step S1010 in FIG. 6 is processing of correcting a label of a three-dimensional shape model on the basis of the predicted object type label.

In FIG. 6, in Step S1001, the prediction unit 103 inputs object property group information including a plurality of pieces of object property information to an input layer of the object disposition property database 102 as described above with reference to FIG. 4. In Step S1002, the prediction unit 103 forward-propagates a computation result using the network of the object disposition property database 102 and obtains an output vector.

In Step S1011, the prediction unit 103 extracts a different element between the output vector and the input object property information. In other words, the prediction unit 103 extracts an object property label replaced by the object disposition property database 102.

Subsequently, in Step S1012, the prediction unit 103 selects a three-dimensional point cloud of the three-dimensional shape model corresponding to the object of the different element extracted in Step S1011. Then, in Step S1013, the object type of the selected three-dimensional point cloud is corrected to the object type output by the object disposition property database 102. The information processing apparatus 1 outputs the thus corrected three-dimensional shape model to the holding unit.

Returning to FIG. 5, in Step S104, the information processing apparatus 1 determines whether or not to end the processing. The information processing apparatus 1 can determine not to end the processing in a case where a user inputs new object property information or object property group information or can determine to end the processing in a case where there is no new input, for example.

In a case where the information processing apparatus 1 determines to end the processing, the information processing apparatus 1 ends the processing as it is. In a case where the information processing apparatus 1 determines not to end the processing, the information processing apparatus 1 executes the processing in Step S102.

As described above, the object property group information including the object type information and the object position information thereof is input, and unknown or incorrect object property information is predicted by the object disposition property database in the first embodiment.

In other words, a fill-in-blank problem is solved on the basis of disposition properties of articles. Labeling or label correction is performed on the three-dimensional shape data using the thus predicted object type labels. It is thus possible to predict an unknown or incorrect object label with high accuracy in consideration of objects in the surroundings and to thereby improve object recognition performance according to the first embodiment.

### First Modification Example

In the first embodiment, the object type information has a data structure in which number labels are allocated to types of objects. Any method may be adopted as a method of expressing the object type information as long as it is possible to determine the types of objects, alphabet labels may be adopted, or character sequence data representing names of objects may also be adopted.

In addition, the method of expressing the object type information may be one-hot expression in which bits of objects are expressed by 1 and the others are expressed by 0. An arbitrary method of expressing data may be adopted for the object type vector as well as long as the object disposition property database 102 can recognize the data.

Also, the three-dimensional coordinates are input as the position vector to the object disposition property database 102 in the first embodiment. The method of describing the position vector is not limited to the simple three-dimensional coordinates, and the position information may be encoded into an output value input to a linear or non-linear function (for example, a trigonometric function) (details are described in the aforementioned method of Ashish et. al.)

The object disposition property database 102 can more easily compare positional relationships among objects through such encoding. Details of these effects are described in the document of Wang et. al. reporting a method of encoring a word position in a case where a transformer is used for sentence analysis.

The document of Wang et. al. is Wang. et. al, On Position Embeddings in BERT, ICLR2021. Encoding of a position as described here leads to more accurate recognition if the object disposition property database 102 compares and selects a prediction method by which it is possible to achieve higher accuracy.

Also, the position information is an object three-dimensional position in the first embodiment. Relative positional relationships of objects may be used as the position information as long as it is possible to represent three-dimensional positional relationships of the objects. The relative positional relationships may be differences in X, Y, and Z coordinates of the individual objects.

Such relative positional relationships are not limited to inputs to the input layer of the transformer and may be input to processing of calculating relationships among elements in an intermediate layer. Specifically, it is possible to apply a method of Cheng et. al. of adding relative positional information (“Music Transformer”, Cheng et. al, arXiv: 1809.04281, 2018).

In this manner, the object disposition property database 102 can more directly process the positional relationships among the objects by using the relative positional relationships among the objects instead of the positions of the objects. Note that these effects are also described in the aforementioned document of Wang et. al.

Also, labels that represent relative positional relationships (specifically, relationship labels corresponding to prepositions that represent locations in a language such as “on”, “in”, and “beside”) may be adopted. Specifically, labels that represent object types and positional relationships and are generated by 3D Semantics Scene Graphs of Wald et. al. (Non-Patent Document 2: Wald. et. al, Learning 3D Semantic Scene Graphs from 3D Indoor Reconstructions, CVPR2020) may be used.

Such 3D Semantic Scene Graphs may be input as object property group information to the object disposition property database 102. In this manner, the object disposition property database 102 can process object connection information (objects are in close contact or spaced apart from each other) and can achieve more accurate recognition.

Also, the object property information is the object type information and the position information in the first embodiment. Furthermore, characteristic information that represents characteristics of objects, such as height, width, and depth values as properties of sizes of the objects, angle values as properties of orientations of the objects, speed values as properties of moving speeds, and color values as properties of color tones, can be input as feature vectors.

Inputs of feature vectors to the object disposition property database 102 can be realized by changing the number of input dimensions of the transformer as needed. The object disposition property database 102 can recognize that the same objects have different characteristics and can achieve more accurate recognition by further applying such characteristic information.

Also, although the CLS token as a start of data is applied to the object type vector such that the object disposition property database can easily perform determination in the first embodiment, the present embodiment can be performed without applying the CLS token.

Moreover, although one piece of object property information generated in one environment is input in the first embodiment, it is also possible to input a plurality of pieces of object property information generated from two or more environments to the object disposition property database. In a case where two or more pieces of object property information are input, the object disposition property database 102 can recognize seams of the individual pieces of object property information by inserting SEQ tokens between the individual pieces of object property information.

The SEQ tokens represent seams of data. The SEQ tokens are inserted into the object type vector and the position vector. In this manner, it is possible to predict the plurality of environments at the same time.

Also, the object disposition property database is a neural network model using a transformer in the first embodiment. However, the present embodiment is not limited thereto as long as it is possible to recognize object disposition properties, a convolutional network, a fully-connected network, an RCN, or the like may be adopted, and there is no particular limitation. Furthermore, the present embodiment is not limited to the neural network model and may be a Bayesian network.

Also, a database that holds the object property information may also be used as the object disposition property database in the present embodiment. In a case where such a database is used, it is possible to adopt a configuration of extracting and outputting object property information similar to input object property information from among object property information registered in the database.

Also, in a case where such a database is used, it is possible to adopt a configuration of extracting most frequently appearing object property information from the object property information registered in the past and outputting the object property information in response to the input object property information.

In a case where such a database is used, it is possible to adopt a configuration of extracting and outputting object property information that is most similar to the input object property information from the object property information registered in the database. The present embodiment can be realized with a smaller amount of calculation as compared with the neural network by using such a configuration.

In the aforementioned embodiment, the method using the object disposition property database to predict an object type label of a three-dimensional shape model and correct an incorrect label has been described. The scope of the application of the present invention is not limited thereto, and the present invention may be applied to arbitrary purposes as long as disposition properties of objects are used.

An example thereof may be a configuration in which object property group information of disposition that has already been known is input to predict object properties located outside the object property group. Specifically, the object property group information of the known disposition and coordinates at which it is desired to predict what object is present outside the object property group are input to the object disposition property database 102 with the position information and the object type information masked.

Note that applying the mask is also referred to as masking. Also, the object type label of the obtained masked portion is the type of the object to be obtained. Such a configuration can also be used to control a moving robot, for example.

For example, it is possible to apply the configuration to an application that fills a region for which data has not been acquired during generation of a three-dimensional shape model by a sensor mounted in a robot, a purpose of performing prediction of an object in a region that has not yet been viewed when a robot recognizes an environment while moving, and the like.

Although the object type information is predicted in the aforementioned embodiment, it is possible to adopt a configuration of predicting object position information, that is, the object disposition property database 102 can be configured as an object disposition property database 102 that predicts unknown or incorrect position information.

Specifically, position information with a mask applied thereto is input to the object disposition property database 102 on the assumption that the object type in the object disposition property database 102 is known. Also, the obtained masked portion and the position information with a changed value are the object position information to be obtained. It is thus possible to predict coordinates where a specific type of object is likely to be located in a three-dimensional space from disposition relationships of objects in the surroundings.

Such a configuration can be applied to a purpose of predicting a position of a desired object (that is, an application for finding where a lost item is located or the like) by masking the position information of the object, for example.

The present embodiment can also be used not only for a configuration of predicting the object type but also for a configuration of determining whether disposition is typical disposition or corresponds to a special rare case. Specifically, type information of an object for which it is desired to determine whether disposition thereof is typical disposition or corresponds to a special case is masked, and the masked type information is input to the object disposition property database 102.

Then, the number of changed elements from the output vector that has been output and the input object property information is calculated as a degree of matching. It is possible to predict that the disposition is typical disposition if the degree of matching is high or the disposition is special disposition if the degree of matching is low.

In the first embodiment, the blank filling and the correction method of the object property group information have been described. Furthermore, it is possible to use the object disposition property database 102 according to the present embodiment in a configuration in which two pieces of object property group information are input and a relationship therebetween is determined. The relationship between the two pieces of object property group information here means whether the location is where the two pieces of object property group information are related.

Here, the object disposition property database 102 is configured to return a true flag to a portion of the first element of the output vector (an element of the CLS in the input vector) if the location is where the two pieces of object property group information are related or return a false flag thereto if the location is not where the two pieces of object property group information are related.

Also, an SEQ token that represents seams of data are inserted into the object type vectors among the individual pieces of object property group information as described above in the first modification example, and the information is input to the object disposition property database 102. It is possible to determine whether or not the locations indicated by the two pieces of object property group information are related locations by the flag corresponding to the CLS portion of the output vector by inputting the two pieces of object property group information to the object disposition property database 102 with such a configuration.

### Second Modification Example

In the first embodiment, the object property group information held by the holding unit, which is not illustrated, is input. A configuration that generates the object property group information may be included. In other words, this may be configured as a measurement system that includes a configuration of generating a three-dimensional shape model and generating object property group information from the three-dimensional shape model. In this modification example, a method of predicting disposition of objects in the surroundings within an unmeasured range and quickly perform labeling while generating a three-dimensional shape model will be described.

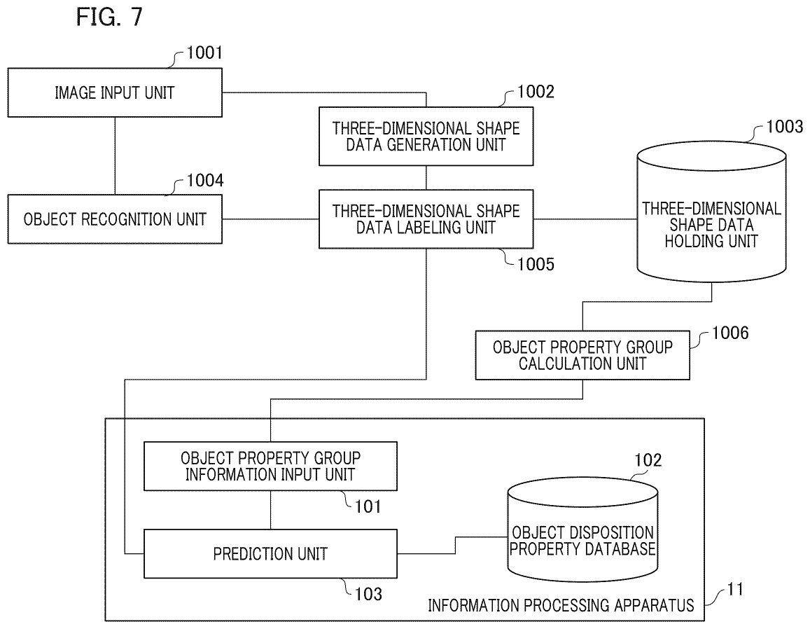

FIG. 7 is a block diagram illustrating a functional configuration of an information processing apparatus according to a second modification example. As illustrated in FIG. 7, some configurations are added to the configuration of the first embodiment illustrated in FIG. 2 in this modification example. The added configurations are an image input unit 1001, a three-dimensional shape data generation unit 1002, a three-dimensional shape data holding unit 1003, an object recognition unit 1004, a three-dimensional shape data labeling unit 1005, and an object property group information calculation unit 1006.

In this modification example, the image input unit 1001 inputs an image from a camera, which is not illustrated. The input image is output to the three-dimensional shape data generation unit 1002 and the object recognition unit 1004.

The three-dimensional shape data generation unit 1002 generates three-dimensional shape data by SLAM. Also, the object recognition unit 1004 performs object labeling on pixels by semantic segmentation on the basis of the input image.

The three-dimensional data labeling unit 1005 allocates the object labels to the three-dimensional shape data on the basis of the thus obtained three-dimensional shape model and the object labels. The three-dimensional shape data holding unit 1003 holds the thus created three-dimensional shape data with the object labels. Details of the series of processing are described in Reference Document 1 above, and detailed description thereof will thus be omitted.

The object property group information calculation unit 1006 extracts object types and position information as object property group information from the three-dimensional shape model with the labels created as described above. Specifically, the object property group information calculation unit 1006 extracts, as the object property information, the label of each object in the three-dimensional shape mode as the object type information and the position of the gravity center of the object as the position information.

Also, the object types of object regions to which labels have not yet been allocated by the method are extracted as unknown object types, that is, the object types thereof are extracted as object type information holding only position information.

The object property information input unit 101 receives an input of the object property group information created as described above. Thereafter, the prediction unit 103 predicts the objects of the unknown labels from disposition of objects in the surroundings as described in the first embodiment. The prediction unit 103 outputs the predicted labels to the three-dimensional shape data labeling unit 1005 and reflects the predicted labels to the three-dimensional shape model.

According to this modification example, it is possible to generate a three-dimensional shape model while accurately recognizing object types using disposition properties by adopting the configuration as described above. Also, if this configuration is mounted in a moving robot, the robot can move while predicting objects and disposition of the objects at a destination of the movement. The moving robot can predict, for example, that a person who is about to jump out and that an article is placed after a corner in advance and safely move by reducing a speed or the like.

Note that the present embodiment can also be configured to determine whether locations where two three-dimensional shape models have been imaged are the same location in a configuration of generating three-dimensional shape models as described in the second modification example. Object property group information generated from a three-dimensional shape model that has already been created by the SLAM and object property group information generated from a three-dimensional shape model that is being created are input to the object property information input unit 101, and the prediction unit 103 obtains an output vector.

At this time, it is possible to determine whether or not the locations indicated by the two pieces of object property group information are the same locations by a flag corresponding to a CLS portion of the output vector. It is thus possible to reduce time and effort to generate the region that has already been generated twice when a three-dimensional shape model of a broad region is generated, for example.

### Third Modification Example

In the first embodiment, the blank filling and the correction of the object property group information and determination regarding whether two pieces of object property group information have been generated at the same location are performed using the object disposition property database that has been trained in advance.

This can be applied to various tasks for understanding an actual space by further adding and holding task databases to solve specific tasks on the basis of such object disposition property databases that can recognize disposition properties of articles.

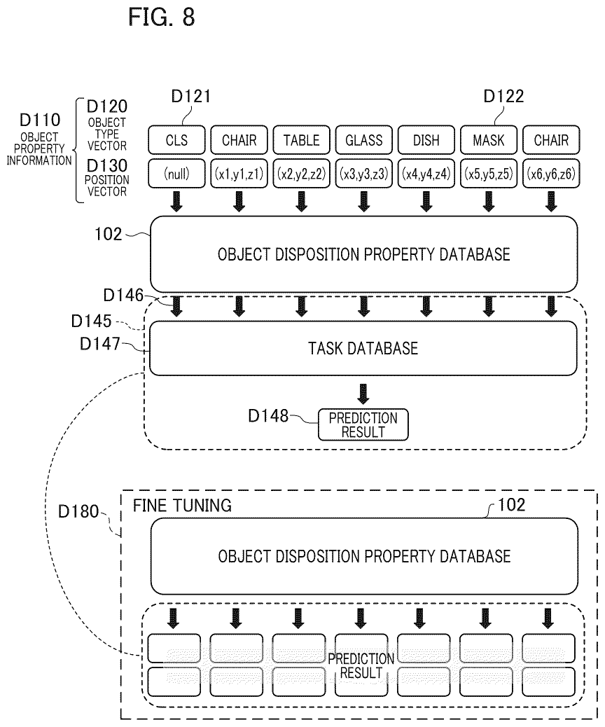

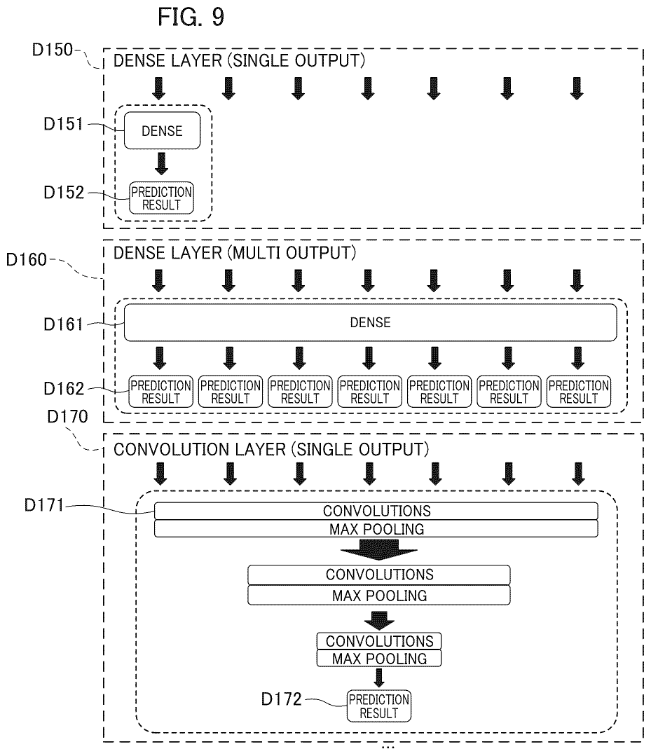

FIG. 8 is a diagram illustrating a concept of a third modification example. FIG. 9 is a diagram illustrating variations of the task database illustrated in FIG. 8. FIG. 8 illustrates a configuration obtained by adding a task database D147 as a decoding layer to an output layer D145 of the neural network that is the object disposition property database 102.

D146 denotes an output vector of the object disposition property database 102, and this is used as an input to the task database D147. The task database D147 forward-propagates the output vector D146 of the object disposition property database 102 and outputs prediction results D148. As will be described later, the number of prediction results D148 may be one or more in accordance with a task.

Each of D150, D160, and D170 illustrated in FIG. 9 is an example of variations of the configuration of the task database D147. Here, three examples, namely D150, D160, and D170 are illustrated.

In this modification example, the task database is a neural network. Specifically, the example of D150 is configured such that a fully-connected layer D151 of one input and one output of the neural network as the task database is connected to a head of the object disposition property database 102 to obtain one prediction result as indicated by D152.

D160 is configured such that a fully-connected layer D161 of multiple inputs and multiple outputs is connected to a plurality of output layers of the object disposition property database 102 to obtain a large number of outputs as indicated by D162. In the example of D170, a three-layer convolutional layer D171 of multiple inputs and one output is connected to a plurality of output layers of the object disposition property database 102 to obtain one output as indicated by D172.

The task database is configured to use the output vector of the object disposition property database 102 as an input and convert the input to obtain an output specialized for another task.

Note that the task database is not limited to the fully-connected layer and the convolutional layer of D150, D160, and D170 as long as it has a configuration of obtaining another output value on the basis of the output of the object disposition property database 102 and may have an arbitrary configuration such as a transformer or an RNN. Also, the task database may be configured to be connected to an intermediate layer instead of being connected to the output layer of the object disposition property database 102.

In this modification example, the case where the object disposition property database 102 is a neural network has been described. If the object disposition property database 102 is a Bayesian network, it is also possible to adopt a configuration to obtain an output on the basis of a binary tree for a feature amount obtained by reducing dimensions of the output vector by PCL.

In addition, the object disposition property database 102 can also be configured as a database that holds other information in association with the output of the object disposition property database 102. With such a configuration, a configuration of searching for data in which the output of the object disposition property information input from the object distribution property database 102 and a cosine similarity are the maximum and outputting information related to the data may be adopted.

A plurality of variations of individual types of task recognition processing based on disposition properties using such a task database will be described below. Note that each task database generation method (learning method) will be described in a modification example of the second embodiment, which will be described later.

A configuration in which a location prediction database that predicts a location label representing a category of a location is used as a task database and a location label indicating where object property information has been generated is predicted will be described as an example. In other words, this corresponds to a configuration that outputs a dining room to D152 for a disposition relationship in which there are a table and four chairs as object property information and a glass and a dish are placed on the table as described in FIG. 1.

Also, this corresponds to a configuration that outputs a school classroom for a disposition relationship in which sets each including one desk and one chair are aligned at equal intervals in longitudinal and lateral directions.

The location prediction database has a network configuration as indicated by D150. It is assumed that the location prediction database is trained to output a location label indicating where object property information has been generated on the basis of an output of the object disposition property database 102 (a learning method will be described in the second embodiment).

It is possible to predict a category of the location from article disposition properties by connecting the database that predicts such a location label to the output layer of the object disposition property database 102. In this manner, it is possible to achieve recognition in consideration of disposition properties of articles in the surroundings as compared with simple object recognition and to thereby more accurately recognize the location category.

It is possible to perform not only prediction of a location but also to easily perform prediction for a target task by changing the task database for a task for which prediction can be performed on the basis of disposition properties of articles. Here, a prediction method based on a task database will be described. The learning method will be described in the second embodiment.

For example, this can be applied to determination regarding whether or not a specific object is likely to move from disposition relationships. Specifically, a task database that inputs object property group information to the object disposition property database 102, outputs a larger value as the individual objects are more likely to move, and outputs a smaller value as the individual objects are less likely to move is used.

In a case where the output is used for Visual SLAM, only features of objects with smaller output values, that is, only features of objects that are predicted to remain still are used for position and posture estimation. In this manner, it is possible to realize a configuration of excluding features of moving objects and to expect an improvement in position and posture estimation accuracy.

If this is applied to automatic driving, it is possible to determine a stopping car is likely to move (the car is stopping at a traffic light) or will remain still (for example, the car is parking at a roadside) and to more safely control the vehicle.

This can also be applied to recognition regarding whether two points are the same point. In other words, this can be applied to a configuration of recognizing where in object property group information (large region) including object property group information (local region) acquired in an environment at a certain point the object property group information is located.

Specifically, a task database that inputs the object property group information (local region) and the object property group information (large region) to the object disposition property database and outputs the same labels to matching objects between the object property group information (local region) and the object property group information (large region) is used.

If such a configuration is applied to Visual SLAM, it is possible to recognize the current position in a large region from disposition relationships of objects in the surroundings if current coordinates are temporarily lost due to hiding by a camera, and to apply the recognition to restore (relocalize) position and posture measurement.

With such a configuration, the object property group information (large region) is generated first from a three-dimensional shape map (model) generated by the SLAM. Next, a temporary three-dimensional shape map is generated from scenes successively imaged by a camera.

Then, the object property group information (local region) is generated from the temporary three-dimensional shape map. The thus generated object property group information is input to the object disposition property database 102, thereby obtaining an object list to which two pieces of object property information correspond.

Positions and postures at which coordinates of these corresponding objects match are calculated through registration of three-dimensional point cloud. Relocalization is performed at the thus calculated positions and postures. In this manner, it is possible to find locations where the camera has moved in the past from the disposition relationships of the articles and to more stably perform the relocalization processing.

This can also be applied to recognition regarding whether or not a disposition relationship of certain objects is abnormal. Specifically, a task database that inputs object property group information to the object disposition property database and returns a binary value indicating normality or abnormality is used.

In a case where such a configuration is applied to automatic driving, objects are detected from an image captured by an RGB camera mounted in a car, and gravity center positions of the objects detected by a depth camera similarly mounted therein are measured. The thus acquired object type and position information are input to the object disposition property database 102.

Normal automatic driving is executed if the output value is normal, or the normal automatic driving is stopped if the output value is determined to be abnormal. In this manner, it is possible to determine something different from usual, that is, abnormality in a case where a traffic accident has occurred in front, for example, and to safely stop in advance. A case where a disposition relationship of articles that does not usually occurs has occurred, for example, a case where a car is stopping with the car facing on a lateral side at a center of a road can be regarded as a case where a traffic accident has occurred.

This can also be applied to prediction of a route from a certain point to another point. In other words, this can be applied to a configuration of predicting a midway route in advance and moving along the route even in an unknown environment. In a case where this configuration is applied to a delivery robot, for example, a task of the delivery robot moving to a room number 103 when the robot is located at an entrance of an apartment to which the delivery robot delivers stuff for the first time will be described.

In order to perform such a task, the object disposition property database 102 is used to calculate that a route of the entrance→a hallway→a room number 101→a room number 102→the room number 103 may be followed as a route for moving from the entrance to the room number 103.

In order to realize such a configuration, a task database that inputs object property group information measured at a certain point and object type labels at the destination to the object disposition property database and predicts the route therebetween is used.

Specifically, a camera mounted in a delivery robot acquires three-dimensional point cloud with labels by the SLAM and generates object property group information. Also, a point designated as a delivery destination is acquired. The location designated as the delivery destination is regarded as an object type, the position information is masked, and these are added to the object property group information.

Also, the object type information with the object type and the position masked is generated and is added to the object property group information. The thus generated object property group information is input to the object disposition property database 102 to thereby obtain an output in which the masked portion has been predicted. The movement to the destination is realized by performing control such that the moving robot follows the thus obtained predicted location. It is possible to perform the moving with minimum time and effort.

The object property group information may be generated from digital twin-data that copies and constructs a real space inside a calculator on a daily basis. In this manner, it is possible to accurately perform an arbitrary prediction task with minimum time and effort on objects included in a virtual space that imitates the real space constructed in the calculator.

### Fourth Modification Example

In this modification example, the object property group information is meta information including object type information and position information. Another mode can also be used instead of such a mode as long as it is possible to determine types and positional relationships of articles. For example, sentence expressing types of articles and relationships among them as sentences may be used as object property information. In other words, the object disposition property database 102 can also be configured as a database that recognizes sentences.

Such a database that recognizes sentences applies the aforementioned method of Jacob et. al. as a neural network that recognizes disposition relationships of words. A user can intuitively recognize inputs and outputs by recognizing object disposition properties using sentences in this manner.

If such an object disposition property database 102 using sentences is used, it is possible to widely apply it to monitoring and retrieval in a real space. Specifically, object property group information acquired in a computer space on a daily basis by a digital-twin or the like is held as sentences.

The sentences and an inquiry sentences for an event that the user desires to monitor or an object that the user desires to retrieve are input to the object disposition property database 102 that recognizes sentences. Then, it is possible to output a response in accordance with the inquiry for object property group information.

With such a configuration, it is possible to realize an inquiry system based on disposition of articles in a real space by sentences, for example, a warehouse management system that makes an inquiry for a location where alignment of articles has changed by sentences or makes an inquiry for a location where a missing article is placed by sentences. More intuitive understanding of the user can be achieved by using sentences.

### Second Embodiment

In the first embodiment, the method of using the object disposition property database indicating disposition of articles in a real space as a database has been described. In the second embodiment, a method of generating (updating) an object disposition property database will be described.

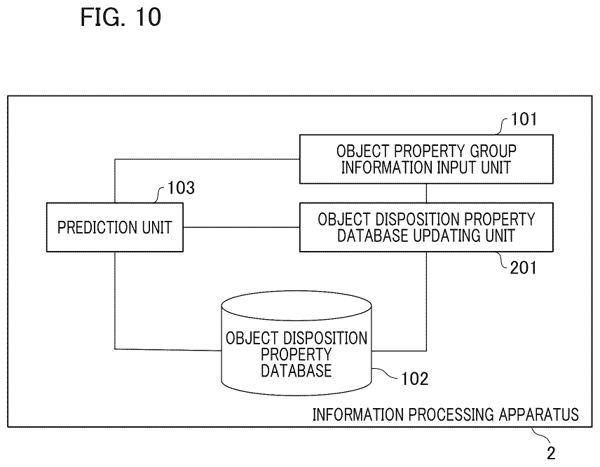

FIG. 10 is a block diagram illustrating a functional configuration of an information processing apparatus according to the second embodiment. In the second embodiment, an object disposition property database updating unit 201 that updates an object disposition property database 102 is added in addition to the configuration described in the first embodiment.

In the present embodiment, an object property group information input unit 101 receives an input of object property group information and outputs the object property group information to the object disposition property database updating unit 201. Also, unlike the first embodiment, modified object property group information that is object property group information obtained by partially modifying object property information is output to a prediction unit 103. The modification will be described later.

The prediction unit 103 outputs object property group information predicted by the object disposition property database 102 to the object disposition property database updating unit 201. The object disposition property database updating unit 201 updates a weight of the object disposition property database 102 on the basis of the object property group information input by the object property group information input unit 101 and the object property group information predicted by the prediction unit 103. The object disposition property database updating unit 201 outputs the updated weight to the object disposition property database 102.

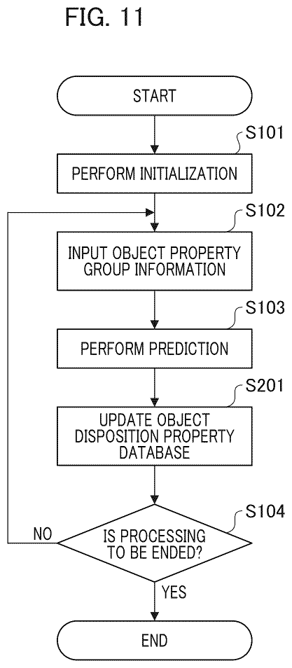

FIG. 11 is a flowchart illustrating a flow of processing of the information processing apparatus according to the second embodiment. In the second embodiment, object disposition property database updating processing in Step S201 is added in addition to the processing procedure described in the first embodiment. The processing described in FIG. 11 is started at the same time as an input an update start signal of the object disposition property database 102 that is input by an input unit, which is not illustrated.

In Step S101, which is processing of initialization in the present embodiment, the information processing apparatus 1 performs initialization processing of the object disposition property database 102 in addition to the processing described in the first embodiment. In other words, the information processing apparatus 1 initializes the weight of the object disposition property database 102 that is a neural network. Although an arbitrary initialization method may be adopted, initialization is performed by a random value generated from a normal distribution with an average of 0 and a variance of 1 in the present embodiment.

In Step S102, the object property group information input unit 101 receives an input of object property group information from a holding unit, which is not illustrated, as described in the first embodiment. Also, in Step S102, the object property group information input unit 101 generates an object type vector and a position vector as described in the first embodiment.

The second embodiment is different from the first embodiment in that some of elements in the object type vector is rewritten. Specifically, the object property group information input unit 101 selects a certain one element with a predetermined random number and replaces an object type label with a mask token (a label indicating that the object type is unknown).

The object property group information input unit 101 outputs the thus modified object property information to the prediction unit 103. Also, the object property information before the modification is output to the object disposition property database updating unit 201.

In Step S103, the prediction unit 103 inputs the object type vector and the position vector included in the modified object property information to the object disposition property database 102. The object disposition property database 102 successively transmits a computation result to the network and obtains an output vector (predicted object disposition properties).

In Step S201, the object disposition property database updating unit 201 updates the object disposition property database 102 on the basis of the object distribution properties predicted by the object disposition property database 102 and the object disposition properties before the modification.

In other words, the object disposition property database updating unit 201 updates the object disposition property database 102 such that the object disposition property database 102 predicts the modified mask portion, that is, such that a fill-in-blank problem of the object property group information is solved.

The updating of the object disposition property database 102 is realized by back propagation of an error, and the neural network is trained by using a method of Diederik in which a weight of the neural network continuously changes.

The method of Diederik is Adam (Diederik. et. al, ADAM: A METHOD FOR STOCHASTIC OPTIMIZATION, ICLR2015).

In Step S104, the information processing apparatus 1 determines whether or not to end the processing, that is, whether or not to end the updating of the object disposition property database 102. Specifically, the information processing apparatus 1 executes the processing in Step S102 in a case where a difference (prediction error) between the predicted object disposition properties and the object disposition properties before the modification has decreased in the process of the updating, or ends the updating if the difference has not decreased.

As described above, the object disposition property database is updated to predict the modified object property information in the second embodiment. In other words, the object disposition property database can predict unknown or incorrect object property information on the basis of disposition properties of objects, that is properties of disposition relationships with objects in the surroundings. More accurate recognition can be realized by using the thus updated object disposition property database.

### Fifth Modification Example

A fifth modification example is a modification example of the second embodiment. The method of initializing the weight of the neural network in Step S101 is not limited to the aforementioned method. The initialization method is an arbitrary method such as the method of Xivier (Non-Patent Document 3: Glorot. et. al, Understanding the difficulty of training deep feedforward neural networks. AIStats2010) and the method of He (Non-Patent Document 4: Kaiming. et. al, Delving Deep into Rectifiers: Surpassing Human-Level Performance on ImageNet Classification, CVPR2015).

An arbitrary method such as a stochastic gradient descent (SGD) or an adaptive gradient algorithm (Adagrad) may be used for the updating of the weight in Step S201 as well. Also, a method of preventing excessing learning by stopping the processing if the prediction error in data that is not used for learning stops decreasing instead of the prediction error at the time of the learning (updating) may be adopted as a condition of ending Step S104.

In this manner, the updating method may be an arbitrary method as long as the difference (prediction error) between the predicted object disposition properties and the object disposition properties before the modification decreases by the method. A method by which higher accuracy can be achieved when updating is performed by a plurality of methods may be employed.

In the present embodiment, the object label in the object property information is masked. On the other hand, a database may be generated as a configuration that masks position information, or a plurality of arbitrary object labels or pieces of position information may be selected and masked.

In this manner, it is possible to recognize the positions of objects regarding where the objects are located when object labels are applied thereto. More accurate recognition can be realized by using the thus updated object disposition property database 102.

Generation of the database is not limited to a configuration of training the database with masking the object property information, and the database may be generated with a configuration of rewriting a selected object label and position information in the object property information with other values. In this manner, a configuration of correcting a corresponding element when incorrect object property information is input can be realized. Furthermore, a configuration in which masking and error correction are performed at the same time may also be adopted. More accurate recognition can be realized by using the thus updated object disposition property database.

In the present embodiment, the object disposition property database is a neural network model. The object disposition property database is not limited to the neural network and may be configured as a database that holds a Bayesian network or object property group information.

In a case where the object disposition property database is updated as a Bayesian network, the updating can be realized by updating the network using object types as nodes and positional relationships with objects in the surroundings as edges and updating probability distribution of each variable by belief propagation (local calculation among variables) using newly input object property information.

In a case where the object disposition property database is configured as a database that holds object property group information, input object property information is held, and degrees of relevance among specific objects are held by calculating the number of times an object has appeared as an object near a focused specific object. In this manner, it is possible to realize a target configuration with less calculation resources than those for the neural network.

In the present embodiment, the object disposition property database 102 is updated such that the fill-in-blank problem of the object property group information is solved. The updating method may be an arbitrary method as long as the object disposition property database 102 can get generality of disposition relationships.

For example, two pieces of object property group information may be input, and the object disposition property database may be updated to determine a relationship therebetween. Specifically, two pieces of object property group information are input, and the object disposition property database is trained such that the CLS portion of an output vector thereof becomes 1 if the two pieces of object property group information are for related locations or such that the CLS portion becomes 0 if the two pieces of object property group information are not for related locations.

The two pieces of object property group information are for related locations means that the object property group information has been generated from three-dimensional shape models created at the same location although the three-dimensional shape models are represented from different viewpoints or in different coordinate systems. The object disposition property database 102 can thus get the determination of the entire disposition as a large region, and recognition performance can be improved.

It is also possible to update the object disposition property database 102 by simultaneously combining the fill-in-blank problem and the matching determination of the two pieces of object property group information. The object disposition property database 102 can thus get an ability of determining the disposition relationships of the individual objects and the relationships of the entire disposition in a large region, and recognition performance can be improved.

Two pieces of object property group information may be input, and the object disposition property database 102 may be updated to provide an output such that the same object has the same ID. The object disposition property database 102 can thus get an ability of determining correspondence regarding which parts of the two pieces of object property group information coincide with each other, and recognition performance can be improved.

The object disposition property database 102 may be updated by using two pieces of object property group information generated from three-dimensional shape models acquired at different clock times. Specifically, it is also possible to update the object disposition property database 102 such that the CLS portion of the output vector of the object disposition property database becomes 1 if the first object property group information has been generated at an earlier clock time, or such that the CLS portion becomes 0 if the first object property group information has not been generated at an earlier clock time.

The object disposition property database 102 can thus recognize disposition relationships in consideration of a chronological order, and recognition performance can be improved.

### Sixth Modification Example

A configuration that updates the object disposition property database 102 while generating object property group information can also be realized. Specifically, the object property group information is generated, and the object disposition property database 102 is updated in a configuration including a unit for generating a three-dimensional shape model using the SLAM as described in the first embodiment.

In this manner, it is possible to update the object disposition property database 102 from an observation result of measurement performed at any time by a movable apparatus, for example. It is thus possible to enhance recognition accuracy of the object disposition property database 102 with data collected moment by moment.

Furthermore, it is also possible to realize a configuration of collecting a three-dimensional shape model or object property group information from a movable apparatus in which a plurality of SLAM systems connected via a network are mounted and updating the disposition property database 102.

In this manner, it is possible to perform update on the basis of a large amount of object property group information in a real space, and the object disposition property database 102 can get more generality. It is possible to improve recognition accuracy by updating the object disposition property database 102 with data in a variety of environments in this manner.

The object property group information may not be based on a three-dimensional shape model generated by the SLAM and may be generated from digital-twin data that copies and constructs a real space in a calculator on a daily basis. Also, the object property group information may be generated from data obtained by simulating digital twin-data in a variety of manners.

In this manner, it is possible to extend variations of the object property group information and to thereby improve generalization performance of the object disposition property database 102. The object disposition property database 102 can thus recognize an event that is unlikely to occur in a real space, for example, and recognition accuracy is improved.

### Seventh Modification Example

It is possible to apply the object disposition property database 102 that recognizes disposition properties of articles as described in the present embodiment to tasks of understanding a variety of actual spaces by adding and holding task databases for solving specific tasks.

Specifically, if the object disposition property database 102 is a neural network, the object disposition property database 102 is regarded as an encoder, and a decoder of a fully-coupled layer and a CNN layer as task databases is added to the output layer.

Additional learning in accordance with tasks is performed only on the decoder layer. It is possible to construct a database that achieve accurate recognition with less time and effort than those required to constitute a task database from the beginning in accordance with each task, by using object disposition properties which are prior knowledge in this manner.

For example, this can be applied to determination regarding whether a certain object is likely to move from a disposition relationship. Specifically, object property group information and a moving object vector (training data) that holds a binary value indicating whether or not each object has moved are prepared.

The object property group information is input to the object disposition property database 102, and the task database is trained such that a difference between an output of the task database and the moving object vector (training data) decreases. It is thus possible to determine whether an object is a moving object using the object disposition properties.

This can also be applied to recognition regarding whether the same point is indicated. Local region object property group information, large region object property group information, and the same object vector (training data) with the same labels applied to the same objects between the local region object property group information and the large region object property group information are prepared.

The local region object property group information and the large region object property group information are input to the object disposition property database 102, and a task database is trained such that a difference between a task database output and the same object vector (training data) decreases. It is thus possible to determine which part of the object property group information (large region) coincides with the object property group information (local region).

This can also be applied to recognition regarding whether or not disposition relationships of certain objects are abnormal. Specifically, object property group information and data (training data) of a binary value storing whether the object property group information is normal or abnormal are prepared.

The object property group information is input to the object disposition property database 102, and a task database is trained such that a difference between an output of the task database and the data (training data) of the binary value storing whether the object property group information is normal or abnormal decreases. It is thus possible to determine whether the object dispositions is normal or abnormal.

This can also be applied to prediction of a route from a certain point to another point. Specifically, object property group information that follows a route along which a movable apparatus moves is prepared. A mask is applied to object label information corresponding to a midway route portion in the moving route of the object property group information, and the object label information with the mask applied thereto is input to the object disposition property database 102.

A task database is trained such that a difference between an output of the task database and the object property group information before the application of the mask decreases. It is thus possible to predict the midway route along which the movable apparatus moves.

In this modification example, a method of adding a task database specialized for a task to the object disposition property database 102 and solving a variety of tasks using disposition properties by updating the task database has been described.

Although the training is performed only with the task database in this modification, a configuration in which the object disposition property database 102 is also trained with the updating of the task database may also be adopted. Thus, the object disposition property database 102 is also updated in accordance with a task, and more accurate recognition can thus be achieved.

Moreover, it is also possible to update the object disposition property database 102 as an object disposition property database 102 specialized for a task by finely tuning the object disposition property database 102 as indicated by D180 in FIG. 8 without adding any task database.

Specifically, training is performed such that a difference between training data which is correct answer data and an output (prediction data) decreases in response to an input to the object disposition property database 102. It is thus possible to solve another task on the basis of the database that recognizes disposition relationships of articles.

Since disposition properties can be recognized in advance with less time and effort even without designing a task database, it is possible to recognize the individual tasks based on the disposition properties in a short period of time without preparing a large amount of data for the individual tasks.

### Eighth Modification Example

In the present embodiment, the method of updating the object disposition property database 102 on the basis of object property group information and the method of application to the individual tasks by updating a task database have been described. The object property group information is meta information including object type information and position information.

It is also possible to constitute the object disposition property database 102 on the basis of sentences without object property group information in a real space, that is, without acquiring or recognizing three-dimensional shapes in the real space, by using object property information that expresses types of articles and relationships among the articles as sentences.

Furthermore, using sentences including the concepts related to the application tasks in the seventh modification example makes the object disposition property database 102 hold these concepts at the same time in addition to the object disposition properties.

The sentences that include the concepts related to the application tasks are sentences that describe disposition of articles and relationships such as a danger, abnormality, and whether the articles move, for example. According to this modification example, the object disposition property database 102 can recognize a variety of tasks from the disposition of the articles only by using the sentences.

In order to realize such a configuration, it is possible to realize the configuration by causing the aforementioned method of Jacob et. al., which is a neural network that recognizes disposition relationships of words, to learn sentences that describes a large number of disposition relationships of objects.

Such object property information expressed as sentences are constructed by the method of Shuquan et. al. (Shuquan. et. al, 3D Question Answering, CVPR2021).

Furthermore, if the data to answer the individual tasks based on the object disposition relationships is previously learned, it is also possible to answer the individual tasks based on the disposition properties by sentences. Specifically, the object property group information acquired in a computer space on a daily basis by a digital-twin or the like, a sentence, and an inquiry sentence for an event that the user desires to monitor or an object that the user desires to retrieve are input to the object disposition property database 102.

Then, this is realized by training the object disposition property database 102 to obtain an output that matches an answer example based on the inquiry sentence. Specifically, this can be realized by applying the method of Yang et. al. that finely tunes a neural network that realizes disposition relationships of words by the aforementioned method of Jacob et. al. using a pair of an input sentence and an output sentence.

The method of Yang et. al. is Wei Yang. et. al, Simple Applications of BERT for Ad Hoc Document Retrieval, arXiv 2019. The user can thus produce the object disposition property database 102 through an intuitive operation. Also, this can be realized without requiring an inquiry system in a real space, time, and effort as described in the fourth modification example of the first embodiment.

Moreover, it is also possible to input sentences related to disposition of articles by a large number of sentences on the Internet to BERTs and train the BERTs in advance. BERTs are abbreviation of bidirectional encoder representations from transformers. It is thus possible to save time and effort to correct a large amount of object property information in a real space and update (train) the object disposition property database.

Although the present invention has been described above in detail on the basis of the preferred embodiments, the present invention is not limited to the above embodiments, various modifications can be made on the basis of the gist of the present invention, and the modifications are not excluded from the scope of the present invention.

Note that a computer program that realizes a part or an entirety of the control in the above embodiments and the functions in the above embodiments may be supplied to an information processing apparatus or the like via a network or various storage media. Then, a computer (or a CPU, an MPU, or the like) in the information processing apparatus or the like may read and execute the program. In that case, the program and the storage media that store the program constitute the present invention.

Also, the present invention includes the functions of the above embodiments realized by using at least one processor or circuit, for example. Note that a plurality of processors may be used and caused to perform the processing in a distributed manner.

What is claimed is:

1. An information processing apparatus comprising:
an object property group information input unit configured to input object property group information that includes at least two or more pieces of object property information, the object property information including type information that represents names of types of objects and information regarding three-dimensional positions of the objects in a space;
an object disposition property database that holds the type information that represents the names of the types of the objects and the information regarding the three-dimensional positions of the objects in the space in an associated manner;
a prediction unit configured to predict information related to the information included in the object property group information on the basis of the object property group information input by the object property group information input unit and the object disposition property database; and
an object disposition property database updating unit configured to update the object disposition property database on the basis of the object property group information input by the object property group information input unit and a result of the prediction of the prediction unit.

2. The information processing apparatus according to claim 1, wherein the position information input by the object property group information input unit is at least any one of the three-dimensional positions of the objects in the space, relative three-dimensional positions among the objects in the space, labels that represent the three-dimensional positions of the objects in the space, and labels that represent relative three-dimensional positions among the objects in the space.

3. The information processing apparatus according to claim 1,
wherein the object property group information input unit generates modified object property group information by performing either masking of at least one of the type information and the position information included in the input object property group information or changing the type information or the position information to other type information or position information,
the prediction unit predicts at least either the type information or the position information as information related to the objects included in the object property group information input by the object property group information input unit or relationships of the objects included in the object property group information, on the basis of disposition relationships of articles in surroundings, and
the object disposition property database updating unit updates the object disposition property database such that a difference between the result of the prediction of the prediction unit and the object property group information input by the object property group information input unit decreases.

4. The information processing apparatus according to claim 1,
wherein the object property group information input unit inputs the at least two or more pieces of object property group information and a flag that represents whether or not the two or more pieces of object property group information are for related locations,
the prediction unit predicts values indicating whether or not locations are related to the object property group information input by the object property group information input unit as information related to relationships of the objects included in the object property group information on the basis of disposition relationships of articles in surroundings, and
the object disposition property database unit updates the object disposition property database such that a difference between the flag input by the object property group information input unit and the flag of the result of the prediction of the prediction unit decreases.

5. The information processing apparatus according to claim 1, wherein the at least one processor or circuit is further configured to function as,
an analogy unit configured to restore a three-dimensional space with object labels of a space from an image and analogizing type information and position information of objects in the restored three-dimensional space as the object property group information.

6. The information processing apparatus according to claim 1, comprising:
a task database that is for solving a specific task by recognizing disposition relationships of articles,
wherein the object property group information input unit further receives an input of training data that is correct answer data of a specific task,
the prediction unit predicts information related to the objects included in the object property group information or information related to relationships of the objects included in the object property group information as prediction data on the basis of the object property group information, the object disposition property database, and the task database, and
wherein the at least one processor or circuit is further configured to function as,
a learning unit configured to learn at least either the object disposition property database or the task database such that a difference between the training data input by the object property group information input unit and prediction data predicted by the prediction unit decreases.

7. The information processing apparatus according to claim 6,
wherein the information related to the relationships of the objects included in the object property group information is a category of a location where the object property group information has been generated,
the training data is a location label that represents the category of the location where the object property group information has been generated,
the task database is a location prediction database that predicts the location label indicating where the object property group information has been generated,
the prediction unit predicts the location label indicating where the object property group information has been generated on the basis of the object property group information, the object disposition property database, and the location prediction database, and
wherein the at least one processor or circuit is further configured to function as,
a learning unit configured to learn at least either the object disposition property database or the location prediction database such that a difference between the location label predicted by the prediction unit and the input location label decreases.

8. The information processing apparatus according to claim 1, wherein the object disposition property database is a neural network model.

9. The information processing apparatus according to claim 1, wherein the at least one processor or circuit is further configured to function as,
a three-dimensional shape data holding unit configured to hold three-dimensional shape data of a three-dimensional shape model in the space; and
an object property group information calculation unit configured to extract a plurality of objects from the three-dimensional shape data and generating the object property group information along with the type information and the position information of the objects.

10. The information processing apparatus according to claim 1, wherein the at least one processor or circuit is further configured to function as,
an image input unit configured to input an image;
a three-dimensional shape data generation unit configured to generate three-dimensional shape data from the image;
an object recognition unit configured to apply object labels to pixels in the image; and
a three-dimensional shape data labeling unit configured to allocate the object labels to the three-dimensional shape data on the basis of the three-dimensional shape data and the object labels.

11. A method of controlling an information processing apparatus comprising:
inputting object property group information that includes at least two or more pieces of object property information, the object property information including type information that represents names of types of objects and information regarding three-dimensional positions of the objects in a space;
predicting information related to the information included in the object property group information on the basis of an object disposition property database that holds the object property group information and the type information that represents the names of the types of the objects in association with information regarding three-dimensional positions of the objects in a space; and
updating the object disposition property database on the basis of the object property group information and a result of the prediction in the predicting.

12. A storage medium that stores a computer program for causing a computer to execute:
inputting object property group information that includes at least two or more pieces of object property information, the object property information including type information that represents names of types of objects and information regarding three-dimensional positions of the objects in a space;
predicting information related to the information included in the object property group information on the basis of an object disposition property database that holds the object property group information and the type information that represents the names of the types of the objects in association with information regarding three-dimensional positions of the objects in a space; and
updating the object disposition property database on the basis of the object property group information and a result of the prediction in the predicting.
